(19) United States
(12) Patent Application Publication
(10) Pub. No.: US 2005/0083192 A1
(43) Pub. Date: Apr. 21, 2005

(54) Method and apparatus employed for warning of the detection of danger situations

(76) Inventor: Jan Kleven, Brennhaugveien (NO)

Correspondence Address: James E. Bradley;BRACEWELL & PATTERSON, LLP, P.O. Box 61389, Houston, TX, 77208-1389, US

(21) Appl. No.: 10/969,405

(22) Filed: Oct. 20, 2004

(30) Foreign Application Priority Data
Oct. 21, 2003 (NO) 20034701

(51) Int. Cl. G08B 29/00

(52) U.S. Cl. 340/506; 340/531

(57) ABSTRACT

Detectors employed in the process of warning of the detection of danger situations such as the detection of smoke, fire, water leakage, gas leakage, etc. The warning takes place by producing an alarm in a number of warning devices after detection of a danger situation by at least one of the warning devices. In order to locate the danger situation, the alarm is reset in a selection of the warning devices.

### CROSS-REFERENCE TO RELATED APPLICATION

This application claims the benefit of Norwegian Patent Application No. 20034701, filed on Oct. 21, 2003, which hereby is incorporated by reference in its entirety.

### FIELD OF THE INVENTION

The present invention relates to a method and apparatus employed for warning of the detection of danger situations, such as the detection of smoke, fire, water leakage, gas leakage, etc.

### BACKGROUND OF THE INVENTION

A range of warning systems for warning of the detection of danger situations, such as the detection of smoke, fire, water leakage, gas leakage, etc. are known. These may be arranged separately. In larger buildings, however, they are often connected. In this manner, the detection of smoke in a room, for instance, can be immediately communicated to the entire building, or parts of the building, so that evacuation, extinguishing attempts at the point of origin, ventilation, drying, and similar actions can be initiated as soon as possible.

Nowadays, such warning systems can have a large range of functions, of which many are very advanced. Most warning systems for larger buildings comprise an operating center, which is connected to all the warning devices. The operating center may comprise a power supply, LED's, or display for the warning of danger situations, and may also indicate which warning device is warning of a danger situation. The latter function requires addressable warning devices, which can communicate with the operating center. This is very useful, as the danger situation can then be located quickly, and an attempt can be made to eliminate the danger situation.

In general, these known warning systems are very expensive, both to purchase and to install. Often, they cannot be used together with ordinary fire and smoke detectors designed for small buildings, such as houses etc. A regular occupant of the building might be able to proceed to the room where at least one warning device is warning of a danger situation because the occupant should be familiar enough with the building to find the way. Fire crews are often not particularly familiar with the buildings, thus may have difficulty finding the way. The persons who are familiar might not be too helpful because they might find the alarm very stressful (the alarm is often an audio signal of up to 90 dB).

Another dangerous situation can also arise, for instance, when a person is awakened by an alarm in the middle of the night. After having checked the house, without discovering the danger situation, he or she may turn off the alarm and go back to bed even though the danager situation still exists. There could be a fire in the basement or in the garage that is not found and which could remained undetected and subsequently cause considerable and unnecessary damage.

### SUMMARY OF THE INVENTION

The main object of the present invention is to provide a method and apparatus employed for warning of the detection of danger situations, which make it possible to indicate in which room the danger situation has arisen, in a fast and very easy manner. Hence, it is desirable to be able to guide persons who are not familiar with the building to the danger situation's point of origin in an easy manner. It is also an object that the invention is suitable for use with existing warning devices such as ordinary fire, smoke, and leakage warning devices for small and medium sized buildings.

The above-mentioned object is achieved by providing an operating center, which is connected to the warning devices, the operating center having a reset switch. When a danger situation is detected, a warning is given from all the affected warning devices, as in the prior art. After the persons in the building have been warned, and one wants to proceed to the danger situation's point of origin, the reset switch can be operated. The term “reset” means that the alarm (preferably a loud audio signal) is stopped, changed, or toned down in a selection of the warning devices. This selection is preferably all of the warning devices, except the one or more warning devices that have detected a danger situation. Thus, the warning device that has detected a danger situation continues producing an alarm so that it can be easily located by, for instance, following the easily recognisable sound from this device.

### BRIEF DESCRIPTION OF THE DRAWING

In the following, the present invention is described by way of example with reference to the attached drawing.

FIG. 1 shows a schematic diagram for a preferred embodiment of the invention.

### DETAILED DESCRIPTION OF THE PREFERRED EMBODIMENT

Known warning devices normally comprise a housing with a detector, where the detector detects a danger situation. Thus, the warning device operates in one of two modes, which correspond to either a normal situation or a danger situation. When detecting a danger situation, the warning device produces an alarm, normally a loud audio signal. Futhermore, the warning devices are often battery-powered. They may also have the possibility of being connected to other warning devices, and also to an operating center by means of three conductors: conductor Vcc representing a voltage supply (typically 9 V), conductor Gd representing earth (typically 0 V), and signal conductor S for signal transmission. The voltage on the signal conductor S will typically equal the voltage of the conductor Gd in normal situations, and equal the voltage of conductor Vcc when a danger situation is detected.

Furthermore, known warning devices normally comprise a series resistance for the signal conductor S. This resistance protects the electronic components in the warning device against over-voltage.

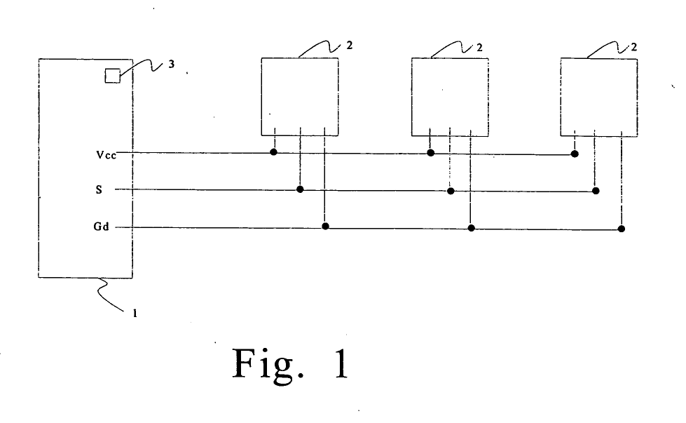

FIG. 1 shows an example of a wiring diagram. The entire warning system comprises an operating center 1, which is coupled to a row of warning devices 2 by means of three conductors Vcc, Gd, and S. The operating center 1 is preferably located near the exit of the building, and may have a few, or many, known functions which are not further described herein. Operating center 1 also has a reset switch 3 such as button, switch, or similar.

The warning devices 2 are preferably of a known type. In this embodiment, they are provided with energy from the operating center 1, via the conductors Vcc and Gd. Thus, the warning devices 2 do not have batteries in this embodiment. The conductor Vcc is the voltage supply (typically 9 V), the conductor Gd is earth (typically 0 V), and the conductor S is used for signal transmission, as described above.

The resetting will now be described in detail. When detecting a danger situation in at least one of the warning devices 2, the warning device 2 that detected the danger situation starts to produce an alarm, for instance, in the form of a loud sound. At the same time, the voltage on the signal conductor S is changed from a voltage level representing NORMAL, to a voltage level representing a DANGER SITUATION, something which causes the other warning devices 2 to produce alarm as well.

Then, to localize the danger situation, the reset switch 3 is used. The reset switch 3 is activated, for instance, by levering the switch, or by pressing the button, etc., and it controls the operation of a resetting device (not shown) in the operating center 1. The resetting device then forces the voltage of the signal conductor S back to the voltage level NORMAL. The warning device or devices 2, that have detected a danger situation, will still try to change the voltage of the signal conductor S to the voltage level representing a DANGER SITUATION, but will not succeed because of the series resistance of the warning devices 2. In this manner, the warning device or devices 2 that have detected a danger situation will continue to produce an alarm. The alarm from the other warning devices 2 will cease. One can now enter the building and follow the sound to the room from which the alarm originates, and then carry out the desired actions such as ventilating after a gas leakage, or extinguish a fire, etc.

The voltage supply for all of the warning devices 2 will preferably be turned off for a period of time after the reset switch 3 is used, to avoiding the inconvenience of being in a room with a loud sound. This time period may, for instance, be from thirty seconds to several minutes, depending on the size of the building.

For setting the warning system back into the normal operating mode, the reset switch 3 can be operated once more, or another switch may be used for this purpose. The above-mentioned resetting device can comprise a short-circuit switch, which short-circuits the voltage on the signal conductor S, or it can comprise a resistor which renders the conductor completely without voltage.

Another form of embodiment is also possible. If each warning device contains a battery, the conductor Vcc can be omitted. After an alarm, the voltage of the conductor S will be changed from the voltage level representing a DANGER SITUATION to the voltage level representing NORMAL, by operating the reset switch. Again, the warning device or devices 2 that have detected the danger situation will then produce an alarm.

It is also possible to use four conductors between the warning devices 2 and the operating center 1. Two of the conductors can be used for the operating voltage, and the remaining two can be used for the transmission of the signals. The resetting device may comprise a short circuit switch between the two conductors that are used for the signal transmission. Nowadays, the use of wireless technology in warning systems is increasing. The warning device 2 that detects a danger situation sends a wireless signal to the operating center 1, which then alerts the other warning devices 2, so that these produce an alarm. When operating the reset switch 3, the operating center 1 will send a signal to one, or several warning devices, to reset these.

The alarm is preferably toned down or stopped completely in the warning devices 2 that have not detected a danger situation, whereas the alarm from the warning device or devices 2 that have detected a danger situation, is maintained. The alarm can also be changed, so that the alarm from the warning devices 2 that don't detect a danger situation, pip with a twenty-second interval, and the alarm from the warning device that has detected a danger situation, pips with a one-second interval.

In another embodiment, each separate warning device 2 may have its own reset switch 3. Then, there is, preferably, no separate operating center, rather each of the warning devices 2 is regarded as an operating center. In this manner, each person in the building can seek out the closest warning device 2, and reset the alarm on each one located until the point of origin can be found. The resetting function is preferably for a selected time period, after which the warning device changes back into normal operating condition, so that all of the warning devices turn back on if the danger situation is not eliminated. This is a good solution, suitable for domestic buildings.

1. A method of warning of the detection of danger conditions, such as the detection of smoke, fire, water leakage, gas leakage, etc., comprising:
connecting plurality of warning devices by wireless or with conductors to an operating center;
producing an alarm in the warning devices after the detection of a danger condition in at least one of the warning devices; and
resetting the alarm in a selection of the warning devices while continuing to produce the alarm in the warning device or warning devices that indicate the danger condition.

2. The method according to claim 1, characterized in that the resetting comprises toning down, stopping, or altering the alarm in the selection of the warning devices.

3. The method according to claim 1, characterized in that the resetting takes place by operating a reset switch at the operating center.

4. The method according to claim 1, characterized in that the resetting takes place by operating a reset switch at the selection of the warning devices.

5. The method according to claim 1, wherein the selection of the warning devices comprises resetting the warning devices that indicate a normal condition.

6. The method according to claim 5, wherein the selection of the warning devices comprises resetting the warning devices that detect a normal condition in a first manner, and resetting the warning devices that detect a danger condition in a second manner.

7. An apparatus for warning of danger conditions, such as detection of smoke, fire, water leakage, gas leakage, etc., comprising a plurality of warning devices that are connected by wireless or with conductors an operating center, wherein the detection of a danger situation by at least one of the warning devices results in a plurality of the warning devices producing an alarm, characterized in that the apparatus comprises a resetting device that can cause the alarm from a selection of the warning devices to be reset.

8. The apparatus according to claim 7, characterized in that the resetting comprises toning down, stopping, or altering the alarm in the selected warning devices.

9. The apparatus according to claim 7, characterized in that the resetting device comprises a reset switch at the operating center.

10. The apparatus according to claim 7, characterized in that the resetting device comprises a reset switch at each of the warning devices.

11. The apparatus according to claim 7, characterized in that the selection of warning devices comprises the warning devices that detect a normal condition.

12. The apparatus according to claim 11, characterized in that the warning devices that detect a normal condition are reset in a first manner, and that the warning devices that detect a danger condition are reset in a second manner.

13. The apparatus according to claim 7, characterized in that the resetting device comprises a switch, an ordinary switch that causes the voltage level of the conductors to maintain a voltage level indicating a normal condition, even if at least one warning device attempts to maintain a voltage level representing a danger condition
